(19) United States
(12) Patent Application Publication
(10) Pub. No.: US 2025/0048029 A1
(43) Pub. Date: Feb. 6, 2025

(54) Microphone and Thin Plate Pressure Attenuator

(71) Applicant: Nittany Acoustics LLC, State College, PA (US)

(72) Inventor: John W. Parkins, Philadelphia, PA (US)

(21) Appl. No.: 18/792,151

(22) Filed: Aug. 1, 2024

Related U.S. Application Data
(60) Provisional application No. 63/517,203, filed on Aug. 2, 2023.

(51) Int. Cl. H04R 3/02; H04R 1/04; H04R 1/10; H04R 1/28

(52) U.S. Cl. CPC H04R 3/02; H04R 1/04; H04R 1/1083; H04R 1/2823; H04R 2201/025

(57) ABSTRACT

A thin plate pressure attenuator includes a housing and a thin plate attached to the housing. The housing and the thin plate together define a first acoustic sound cavity. The housing can include a base and an annular wall. A microphone can be acoustically coupled to the sound cavity.

### REFERENCE TO RELATED APPLICATIONS

This application claims one or more inventions disclosed in Provisional Application No. 63/517,203, filed Aug. 2, 2023, titled “Microphone Pressure Divider”. The benefit under 35 USC § 119(e) of the United States provisional application is hereby claimed, and the aforementioned application is hereby incorporated herein by reference.

### ACKNOWLEDGMENT OF GOVERNMENT SUPPORT

This invention was made with Government support under contract W81XWH22C0082 awarded by the USA MED RESEARCH ACQ ACTIVITY. The Government has certain rights in the invention.

### BACKGROUND OF THE INVENTION

### Field of the Invention

This invention pertains to the field of microphones and, in particular, to a device that can beneficially modify the performance of microphones.

### Description of Related Art

An audio microphone, such as a micro-electromechanical systems (MEMS) microphone, is a sensor that provides an electrical output proportional to a pressure of an audio signal often resulting from the vibration of a flexible membrane. MEMS microphones are prevalent in audio system designs because of their high performance and low cost.

FIG. 1 illustrates a known MEMS microphone 1. Referring to FIG. 1, a flexible membrane 2 acoustically communicates with its ambient environment through a sound port 13. The sound port 13 includes a hole through a housing 16. The housing 16 can include a case 17 attached to a PCB 5. The case 17 can protect one side of the membrane 2 from being exposed to ambient sound pressure from audio signals. The illustrated MEMS microphone 1 is a bottom-ported microphone, in which the sound port 13 extends through a bottom or base, which is a printed circuit board (PCB) 5. Some MEMS microphones are top-ported microphones (not shown), though, in which a sound port instead extends through a top, such as the case 17. Typically, monopole microphone designs feature only one sound port.

Still referring to FIG. 1, the membrane 2 is attached to a support structure 3, which is further attached to the PCB 5 inside the housing 16. Some microphones incorporate multiple membranes. The support structure 3 internally houses electronics (not shown) that convert the membrane 2 vibrations to an electrical signal that is output in a wire 9. This wire 9 is often attached to an electronic chip 7 that provides amplification and other electronic features. As noted above, the case 17 is attached to the PCB 5 to prevent one side of the membrane 2 from being exposed to ambient sound pressure from audio signals. The case 17 and the PCB 5 together form an acoustic back cavity 11. Electrical solder pads 15 provide electrical access to the electrical output from the electronic chip 7 and enable connection to a power supply (not shown) to supply power to the electronic chip 7. A vent 19 through the membrane 2 provides static pressure equalization for the acoustic back cavity 11. Note that the acoustic back cavity 11 can also be vented by providing a small hole in the case 17 or PCB 5. Back cavities are typically made large enough to avoid too much acoustical impedance on the membrane 2. High acoustical impedance reduces the vibrations of the membrane 2, and a reduction of the vibrations causes a lower sensitivity of the MEMS microphone 1, which can be undesirable.

Known audio MEMS microphones typically can measure pressures only as high as approximately 132 dB SPL before appreciable distortion and can tolerate only approximately 160 dB SPL before damage occurs. (This negative result is also encountered with other inexpensive commercial microphones, such as the electret variety.) Soldiers, however, are exposed to much higher impulse levels due to explosions and weaponry, which can damage or destroy the microphones. Thus, it is desirable to protect microphones from overpressure in certain applications.

Moreover, the dynamic ranges of known MEMS microphones are typically not optimized for use in noise dosimetry. A higher performance MEMS audio microphone, such as the Knowles® SPA1687LR5H-1, has a dynamic range of approximately 29 dB SPL to 132 dB SPL. Levels less than 80 dB SPL, however, do not typically contribute to the accumulated noise dosage for noise dosimeters used in the USA. Thus, for this microphone with 103 dB dynamic range, only the range from 80 dB to 132 dB (52 dB) is utilized. Using this microphone would limit the dynamic range of a noise dosimeter compared to the 103 dB dynamic range that could be possible.

MEMS microphones can be made very small, which makes them easier to fit in smaller devices. For example, the Knowles® SPA1687LR5H-1 microphone measures less than 3 mm in width, 4 mm in length and 1 mm in thickness. It is desirable for sensing devices, in general, to be as small as possible as larger devices may not be practical in certain applications. Moreover, it is usually advantageous for pressure sensing devices to be small because the response of the sensor can be distorted if the size of the sensor approaches the length of an acoustical wavelength of a frequency being measured. Acoustical standing waves and resonances can become a problem in this case.

Special microphones could be constructed with stiffer membranes to shift the dynamic range higher, but because doing so would require significant redesign of current microphones and because the number of these microphones would be small relative to the number of typical microphones, these special microphones would be relatively expensive.

It is desirable to shift the dynamic range inexpensively and to provide protection of the microphone at high sound pressures, especially for applications such as noise dosimetry, impulse noise detection, and general acoustic monitoring of a soldier.

Moreover, the membranes of typical microphones are fragile. Water and debris, for example, can clog the sound port and destroy the electronic functioning. Chemicals can destroy microphone membranes. Accordingly, it is desirable to protect the sensitive microphone membrane from elements, such as water, chemicals, sand, and dust, and from physical puncture, especially with military applications.

### SUMMARY OF THE INVENTION

A thin plate pressure attenuator (TPPA) is a microphone modification device that can modify the performance of known inexpensive microphones to shift the dynamic range and to provide protection of the microphone from high sound pressures, especially for applications such as noise dosimetry, impulse noise detection, and general acoustic monitoring of a soldier. The TPPA can achieve the desired performance change by attenuating the pressure sensed by a microphone uniformly as a function of frequency within frequencies of interest. The TPPA also can protect the membrane of a microphone from the environment, such as water, chemicals, sand, dust, sharp objects, fingers, and other potential hazards.

In an embodiment, a thin plate pressure attenuator includes a housing defining a sound cavity, a thin plate attached to the housing, and a microphone coupled to the sound cavity.

In an embodiment, a thin plate pressure attenuator includes a housing and a thin plate attached to the housing. The housing includes a base and an annular wall. The housing and the thin plate define a first acoustic sound cavity.

In an embodiment, a microphone includes a housing, a thin plate attached to the housing, a first printed circuit board attached to the housing, a case attached to the first printed circuit board, a support structure attached to the first printed circuit board, and a membrane attached to the support structure. The thin plate and the housing define a first acoustic cavity, the first printed circuit board and the case define a second acoustic cavity, and the support structure is in the second acoustic cavity.

### BRIEF DESCRIPTION OF THE DRAWINGS

FIG. 1 shows a cross-sectional view of a known MEMS microphone.

FIG. 2 shows a cross-sectional view of a microphone including a MEMS microphone and a TPPA, according to an embodiment of the invention.

FIG. 3 shows a cross-sectional view of a microphone including a MEMS microphone and a TPPA, according to another embodiment of the invention.

FIG. 4 shows an electrical schematic of a model equivalent to the TPPA of FIG. 2.

FIG. 5 shows a cross-sectional view of a microphone including an electret microphone and a TPPA, according to an embodiment of the invention.

FIG. 6 shows a cross-sectional view of a microphone including an electret microphone and a TPPA, according to another embodiment of the invention.

### DETAILED DESCRIPTION OF THE INVENTION

The terminology used herein is for the purpose of describing particular example embodiments only and is not intended to be limiting. As used herein, the singular forms “a”, “an”, and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an clement is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the Figures. Spatially relative terms may be intended to encompass different orientations of the device in use or operation in addition to the orientation depicted in the Figures. For example, if the device in the Figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Notwithstanding that the numerical ranges and parameters setting forth the broad scope of embodiments are approximations, the numerical values set forth in the specific examples are reported as precisely as possible. Any numerical value, however, inherently contains an error tolerance necessarily resulting from the standard deviation found in its testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less than 10” can assume negative values, e.g. −1, −2, −3, −10, −20, −30, etc.

The terms “approximately” and “about”, when qualifying a quantity, shall mean the quantity with a tolerance plus or minus 10 percent of the quantity, unless otherwise specified.

A thin plate pressure attenuator (TPPA) shifts the dynamic range of microphones, including commercially available microphones, and protects microphone membranes from higher sound pressures. The TPPA achieves the desired performance change by attenuating the pressure sensed by a microphone uniformly as a function of frequency in frequencies of interest. These frequencies of interest may include audio, ultrasonic, or subsonic, as known in the art. The TPPA also protects the membrane of a microphone from the environment, such as water, chemicals, sand, dust, sharp objects, fingers, and other potential hazards.

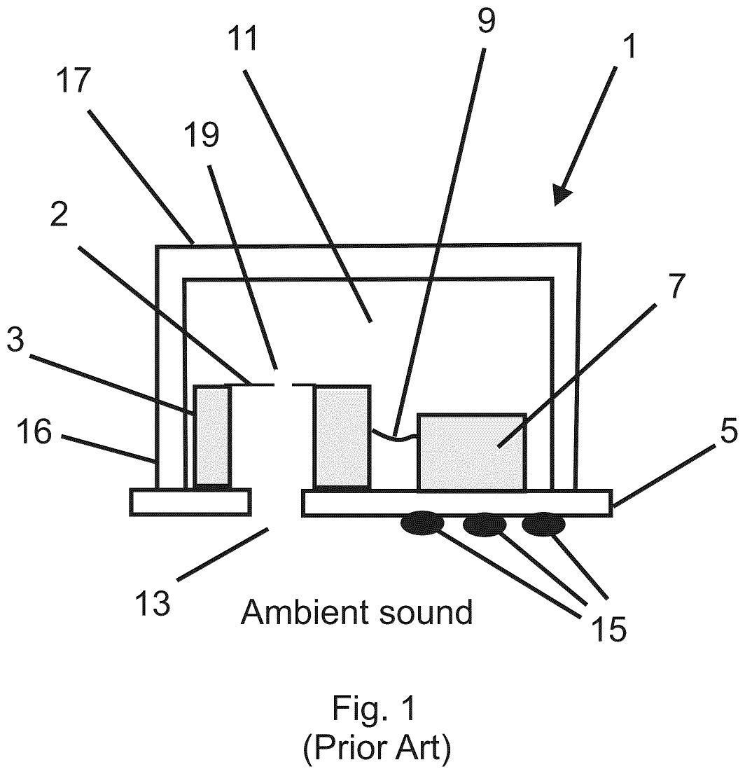

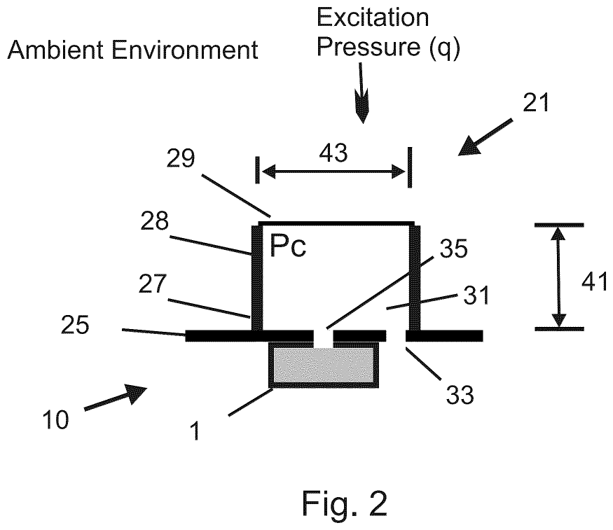

FIG. 2 shows a cross-sectional view of a microphone 10, which includes the MEMS microphone 1 (see FIG. 1) modified to incorporate a TPPA 21. The TPPA 21 functions to shift a measurement pressure range to significantly higher pressure levels compared to what can be achieved using the MEMS microphone 1 alone. The MEMS microphone 1 (see FIG. 1) is soldered to the TPPA 21.

More particularly, the TPPA 21 includes a housing 27, which further includes an annular housing wall 28 attached to a base 25. The base 25 can include or can be a printed circuit board. The housing wall 28 has an inner diameter 43 and a height 41. While the housing wall 28 of FIG. 2 is cylindrical, in other embodiments, the housing wall can have other annular geometries as desired. A cylindrical geometry facilitates structural rigidity. The housing wall 28 can be made from cylindrical metal tubing. The housing wall 28 can include one continuous wall segment or a series of intersecting or jointed wall segments.

The TPPA 21 also includes a thin plate 29. The use of the term “thin plate” herein refers to a sheet of material that falls within the thickness range where the sheet vibrates according to thin plate vibration theory. Thin plate vibration theory is known in the art. For a given material, the material will vibrate according to thin plate vibration theory only if the thickness is within a specific range herein defined as “thin”. Outside of this range of thickness herein defined as “thin”, the material will not vibrate according to thin plate theory. Thin plates can be made of materials such as metal or non-metal materials.

The thin plate 29 is attached to the housing wall 28 using, e.g., glue, welding, crimping, or other now-known or future-developed techniques. The housing wall 28 and the thin plate 29 can be made of stainless steel or other materials more corrosion-resistant and/or puncture-resistant than a typical microphone membrane. Accordingly, the TPPA 21 is significantly more durable than a typical microphone using a membrane. This durability is important in military environments.

The housing 27 and the thin plate 29 together define a sound cavity 31 therein. As the result of an ambient excitation pressure q impinging on the TPPA 21, the thin plate 29 vibrates. The thin plate 29 has a first effective acoustical compliance (Cₚ), and the sound cavity 31 has a second effective acoustical compliance (C_{c}), which together form a pressure attenuator network analogous to an electrical voltage divider. (Note that the inverse of acoustical compliance is acoustical stiffness.) An acoustic vent 33 is provided to avoid or eliminate static pressure differential between the ambient environment and the sound cavity 31. The size of the acoustic vent 33 is chosen to avoid affecting the frequency response measured by the microphone 10 in the frequency range of desired measurement, and to equalize the static pressure relatively quickly. Equalizing the pressure reduces or prevents bulging of the thin plate 29. Bulging of the thin plate 29 can affect performance of the TPPA 21 by stiffening the thin plate 29. The MEMS microphone 1 is acoustically coupled to the sound cavity 31 via a sound port 35 through the base 25. In this way, the microphone 10 measures the pressure P_{c} in the sound cavity 31 which correlates with the ambient excitation pressure q. Using the base 25 as one surface defining the sound cavity 31 enables the MEMS microphone 1 to be easily attached to the TPPA 21 and enables an efficient way to acoustically couple the MEMS microphone 1 to the sound cavity 31.

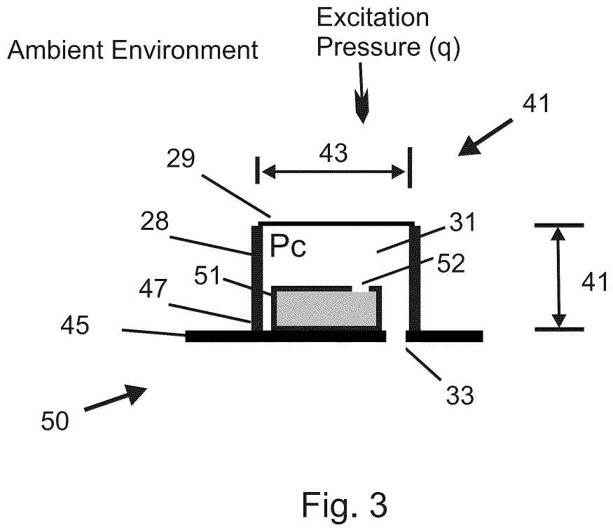

FIG. 3 shows a cross-sectional view of a microphone 50, which includes a top-ported MEMS microphone 51 modified to incorporate a TPPA 41. The TPPA 41 of FIG. 3 is like the TPPA 21 of FIG. 2, except that the TPPA 41 of FIG. 3 includes a housing 47 that includes a base 45 that omits the sound port 35. The top-ported MEMS microphone 51 is soldered to the TPPA 41 inside the sound cavity 31 with a top port 52 opening to the sound cavity 31.

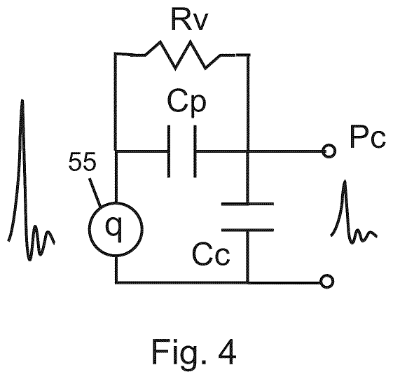

FIG. 4 shows an acoustic lumped element equivalent electrical model of the TPPA 21. Referring to FIG. 2 and FIG. 4, the excitation pressure q is represented as a voltage source 55 with the first effective acoustical compliance Cₚ (of the thin plate 29) and the second effective acoustical compliance C_{c} (of the sound cavity 31) forming a pressure attenuator, which attenuates the excitation pressure q. The acoustic vent 33 can often be modeled effectively as an acoustic resistance Rᵥ, which shunts the first effective acoustical compliance Cₚ (of the thin plate 29). At frequencies above which the vent has no appreciable acoustical effect and the sound wavelengths are large compared to the dimensions of the microphone 10, the response pressure Pc is generally constant as a function of frequency but is attenuated and can be calculated by the equation,

$${P}_{c} = \frac{1 + {R}_{v} {C}_{p} s}{1 + {R}_{v} {C}_{p} s + {R}_{v} {C}_{c} s} \qquad ( 1 )$$

where s=2πjƒ and ƒ is frequency.

At low enough frequencies, the pressure P_{c} inside the cavity is the same as the pressure of the excitation pressure q. At frequencies above which the vent 33 has little effect, the response is approximately

$${P}_{c} \approx \frac{{C}_{p}}{{C}_{p} + {C}_{c}} \qquad ( 2 )$$

and is constant as a function of frequency. If C_{c}>>Cₚ, equation (2) further simplifies to

$${P}_{c} \approx \frac{{C}_{p}}{{C}_{c}} \qquad ( 3 )$$

For attenuations in the 50 dB range, the stiffness of the thin plate 29 would be approximately 316 times the stiffness of the sound cavity 31, raising the decibel level the microphone 1 can handle before being damaged to 210 dB SPL and the maximum SPL before significant distortion from 132 dB SPL to 182 dB SPL. The attenuation of the invention can be modified to achieve a wide range of levels by varying the compliance of the thin plate 29 and/or varying the volume of the sound cavity 31. An attenuation of at least 10 dB is considered to be significant because the resulting pressure range would allow a given microphone to be used in acoustic environments that are perceived to be approximately twice as loud.

The highest speech frequency in telephony for reasonable communications is often considered to be less than 4 kHz, corresponding to an acoustic wavelength of approximately 8.6 cm. However, a rectangular sound cavity with a longest dimension of 4.3 cm would have a first resonance at 4 kHz due to relatively rigid boundary conditions. It is generally undesirable when measuring acoustic speech signals to have microphone resonances within the speech band if an accurate measurement of the speech signal is required. In some embodiments, the maximum length of any linear dimension within the sound cavity is less than 4.3 cm.

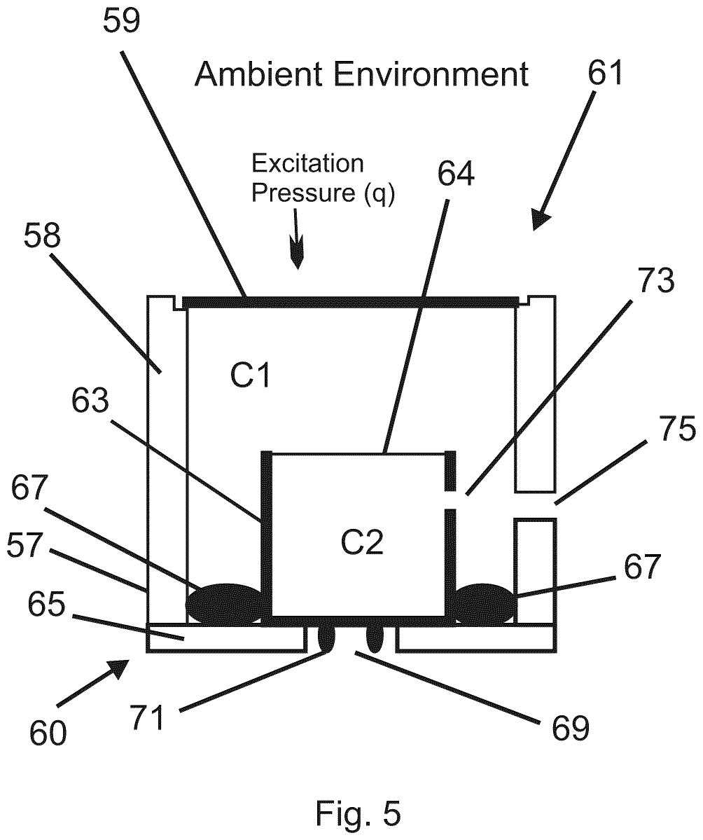

FIG. 5 shows a cross-section of a microphone 60 including a TPPA 61 attached to an electret microphone 63 instead of a MEMS microphone. Similar to the TPPA 21 of FIG. 2, the TPPA 61 of FIG. 5 includes a thin plate 59 attached to a housing 57, which includes an annular housing wall 58 attached to a base 65. The thin plate 59, the housing wall 58, and the base 65 together define a front acoustic cavity C1 therein. The base 65 can include or can be a PCB.

The electret microphone 63 is secured to the housing wall 58 inside the front acoustic cavity C1 using glue 67, though other now-known or future developed fasteners or fastening means can be used. The electret microphone 63 has a back acoustic cavity C2 therein. The electret microphone 63 has a membrane 64 that vibrates in response to pressure in the front acoustic cavity C1. It is known in the art how to convert the vibration of a membrane into an electrical signal using various techniques such as the use of an electret material back plate, an amplifier, and conductors (not shown). The back acoustic cavity C2 is large enough to limit stiffness loading on the membrane 64 that would reduce the sensitivity of the microphone 63.

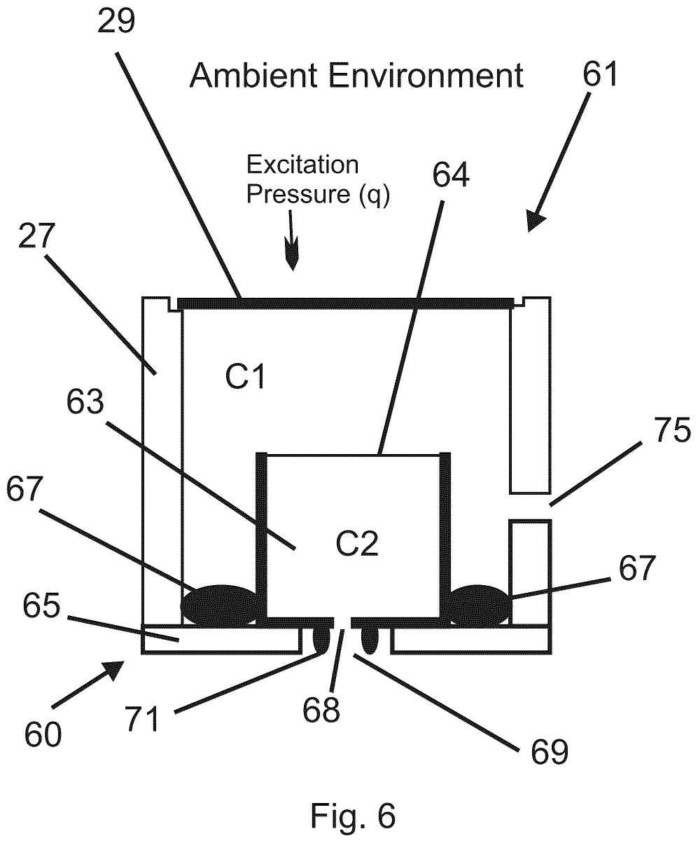

A hole 69 in the base 65 allows access to solder pads 71 of the electret microphone 63. The glue 67 reduces or prevents acoustic leakage between the base 65 and the front acoustic cavity C1. The back acoustic cavity C2 of the electret microphone 63 has a first vent 73 to equalize the static pressure of the front acoustic cavity C1 and the back acoustic cavity C2 in a repeatable and controlled way in part because the hole 69 can be provided with precise dimensions. A second vent 75 in the housing wall 58 equalizes the pressure of the front acoustic cavity C1 with the ambient environment static pressure. The first vent 73 and the second vent 75 are small enough to avoid affecting the frequency response of the TPPA 61 at frequencies of interest. In this way, the thin plate 59 provides the pressure attenuator function described with respect to FIG. 4, while the electret microphone 63 provides the pressure sensing and electrical signals at solder pads 71. Note that the effective compliance behind the thin plate 59 includes the compliance of the front acoustic chamber C1. The effective compliance, however, is smaller than the compliance of the volume of the front acoustic chamber C1 due to the stiffness of the membrane 64. Instead of venting the electret microphone 63 into the front acoustic chamber C1 the electret microphone 63 can be vented directly to the ambient environment through the base 65 near the solder pads 71. As seen in FIG. 6, an optional vent hole 68 in the electret microphone 63 can extend through the base 65 near the solder pads 71 for this purpose. In this embodiment, the first vent 73 can be omitted.

The electret microphone 63, being placed inside the housing 57 of the TPPA 61, displaces the volume in the front acoustic cavity C1, lowering the compliance impedance on the thin plate 59 and reducing the pressure attenuation. Measurements can be taken to determine the actual attenuation. If the attenuation is less than desired, the volume of the front acoustic cavity C1 can be increased.

The constants and parameters used in the following analysis of a circular thin plate are provided in the following table for easier reference.

TABLE 1
Parameters for stainless steel 18-8 304 thin plate material
with indicated thickness and radius with clamped edge.
(Parameters may vary depending on plate manufacturer.)

| Sym- | | | |
|---|---|---|---|
| bol | Name | Value | Units |
| q | excitation pressure | not defined | Pa |
| h | thickness | 50.8 × 10⁻⁶ (2.0 mil) | m |
| a | radius | 2.38 × 10⁻³ (3/32 in) | m |
| ρₚ | density | 7.85 × 10³ | Kg/m³ |
| v | Poisson's ratio | 70.2 × 10³ | none |
| E | Young's modulus | 190 × 10⁹ | Pa |
| D | bending rigidity | 2.23 × 10³ | Pa · m³ |
| fₒₚ | fundamental | 21.5 | kHz |
| | resonance | | |
| Cₚ | plate acoustic | 1.33 × 10⁻¹⁵ | m⁴sec²/kg |
| | compliance | | |
| wₘₐₓ | maximum plate | wₘₐₓ = qa⁴/(64D) | m |
| | displacement | | |
| wₐᵥₑ | average plate | wave = wmax/3 | m |
| | displacement | | |

### Thin Plate Versus Membrane Vibration

The following discussion of thin plate vibration is known in the art as thin plate vibration theory and the following discussion of membrane vibration is known in the art as membrane vibration theory. For a given material, the material will vibrate according to thin plate vibration theory only if the thickness is within a specific range. Outside of this range of thickness, the material will not vibrate according to thin plate theory. The use of the term “thin plate” herein refers to a sheet of material that falls within the thickness range where the sheet vibrates according to thin plate vibration theory. Thin plates, as the term is used herein, can be made of metal or non-metal materials.

The TPPA 21, 61 utilizes a thin plate 29, 59 as the vibrating diaphragm that provides the pressure attenuation (along with the compliance of the cavity) instead of using a membrane. The main difference between membranes and thin plates is that the restoring force of membranes is due to tension applied to the membrane, while with thin plates the restorative force is due to the stiffness of the thin plate and no tension needs to be applied to achieve a restorative force as is known in the art. Note that the thin plate and membrane theories assume small vibrational displacements.

Thin plate vibration is described by equation,

$$D {∇}^{4} w = - {ρ}_{p} h {\partial }^{2} w / \partial {t}^{2} \qquad ( 4 )$$

where w is displacement as a function of x, y, and t, ρₚ is the material density, h is the thin plate thickness, and D is the bending rigidity defined by

$$D = \frac{{Eh}^{3}}{12 ( 1 - {v}^{2} )} \qquad ( 5 )$$

The bending rigidity of the thin plate provides additional equivalent acoustic stiffness compared to a material/geometry that acts as a membrane.

A membrane generally exhibits the relationships described by equation

$${∇}^{2} y = \frac{1}{{c}_{m}^{2}} \frac{{\partial }^{2} y}{\partial {t}^{2}} \qquad ( 6 )$$

where y is displacement as a function of x, z, and t, cₘ₌\sqrt{T/ρₘ} is the speed of wave propagation in the membrane, T is the tension of the membrane, and ρₘ is the density of the membrane material. A material/geometry that acts as a membrane is generally dependent only on the tension of the material and the material density, whereas with a thin plate the Young's Modulus, Poisson's Ratio, density and thickness must all be considered. Membranes generally do not have flexural rigidity, while thin plates do.

Thus, membranes and thin plates behave very differently. Generally, thin plates provide much higher stiffness compared to membranes. Beneficially, as opposed to membranes, thin plates do not need to be tensioned. Tensioning membranes requires a sensitive and controlled manufacturing process.

The plate thickness must be within a specific range, which can vary by material type. If the plate is too thick, the membrane will not behave according to the equations discussed herein due to additional shearing forces when vibrating. If the material is thin enough, the plate will generally behave as a membrane if the plate is put under tension.

The resonance frequencies of a thin plate versus a membrane can be derived from equation (4) and equation (6) when a circular thin plate is clamped and a circular membrane is rigidly secured at their outer boundaries. The fundamental resonance of the thin plate can be calculated by the equation

$${f}_{\text{?}} = \frac{10.22}{2 π {a}^{2}} \sqrt{\frac{D}{{ρ}_{p} h}} , \qquad ( 7 )$$

$$\text{?} \text{indicates text missing or illegible when filed}$$

while the fundamental resonance of the membrane can be calculated by the equation

$${f}_{\text{?}} = \frac{2.41}{2 πα} \sqrt{\frac{T}{{ρ}_{m}}} \qquad ( 8 )$$

$$\text{?} \text{indicates text missing or illegible when filed}$$

Note that if a membrane is not tensioned, the resonance frequency tends toward zero, while a thin plate does not require tensioning to have a resonance frequency. Note that the thin plate resonance is proportional to the thickness of the thin plate and 1/a². A stainless steel 18-8 304 thin plate, based on table 1 and a chamber volume of 84.7×10⁻⁹ m³, has a theoretical fundamental resonance of 21.5 kHz.

A material with specified geometry (thickness, dimensions, boundary conditions) is considered here to be a thin plate if the fundamental resonance is more accurately described by equation (7) compared to equation (8) and is reasonably described by equation (4), while a material with specified geometry is considered to be a membrane if its fundamental resonance is more accurately described by equation (8) compared to equation (7) and is reasonably described by equation (6). If the material is not shaped as a disc, more complicated resonance equations can be determined from equation (4) and equation (6), or simulations based on these equations can be used to determine if the material acts as a thin plate or membrane.

The fundamental resonance may be measured by cutting the material to the desired shape and fixing the material to the support consistent with the intended geometry and supporting structure of the design to be used. The support can be attached to a microphone stand using a boom to hold the material in a relatively reflection-free space, such as an anechoic chamber. An acoustic impulse generator, such as a blank round fired by a gun, can be used to acoustically stimulate the material. A laser vibrometer can be pointed at the surface of the diaphragm to measure the diaphragm movement and a spectrum analyzer can be used to measure the spectrum of excited movement of the diaphragm. The spectrum peak measured after the initial impulse indicates the fundamental resonance.

Use of the thin plate instead of a membrane for the TPPA enables significantly higher attenuations and significantly better protection of a microphone because a thin plate is typically stiffer and less penetrable by foreign objects compared to a membrane. Moreover, a TPPA can be constructed more inexpensively using a thin plate as the diaphragm because the thin plate does not require tensioning. In addition, if the TPPA incorporates a metal thin plate as the diaphragm, the metal housing wall can be soldered to a circuit board, whereas most membranes would not be able to tolerate the high temperatures. The membrane tension tends to relax at the high heat required for soldering or reflow.

### Compliance

The equivalent acoustic compliance of the clamped disc with radius a can be determined by finding the average deflection of the disc given a pressure excitation and using Hooke's law. The deflection is characterized by the equation

$$w ( x , y ) = {q ( {x}^{2} + {y}^{2} - {a}^{2} )}^{2} / ( 64 D ) \qquad ( 9 )$$

where the disc is centered at x=y=0, with x<a and y<a, and the disc is subject to a uniform acoustic pressure q. The maximum deflection occurs at the center of the disc (x=y=0) and is equal to wₘₐₓ=qa⁴/(64D).

The average deflection can be found by integrating equation (9) over the disc area using polar coordinate substitution (x=r cos θ, y=r sin θ, and dxdy=rdrdθ) and dividing by the area (A=πa²), which yields wₐᵥₑ=wₘₐₓ/3.

Hooke's law states that force on a spring is proportional to the stiffness of the spring times the displacement (F=kx). If instead we are dealing with pressure q impinging on our thin plate disc then the equation becomes q=Akwₐᵥₑ and

$${C}_{p} = 1 / k = π {a}^{6} / ( 192 D ) \qquad ( 10 )$$

is the equivalent acoustic compliance of the plate for use in lumped element analysis. Using the values from table 1, we find that the equivalent compliance is equal to 1.33×10⁻¹⁵ m⁴sec²/kg.

The equivalent acoustic compliance of a volume chamber is Cᵥ=V/(ρₐc²ₐ), where V is the volume of the chamber, ρₐ is the density of air (1.21 kg/m³), and cₐ is the speed of sound (343 m/sec²). If we use a pressure divider with a height of 4.76×10⁻³ m ( 3/16 in), the volume of the chamber is 84.7×10⁻⁹ m³ and the equivalent compliance is 595×10⁻¹⁵ m⁴sec²/kg.

As shown in equation (3), the attenuation of the geometry described in this example would be Atten=595×10⁻¹⁵/1.33×10⁻¹⁵=2.24×10⁻³ or 53 dB attenuation. The device was tested in the laboratory and found to have an attenuation of 52 dB.

Note that the effective compliance of a thin plate is proportional to a⁶ and 1/h³, while the compliance of a membrane is theoretically infinite unless it is under tension.

Sometimes microphones are protected by using gas-permeable acoustic vents or other thin materials to cover the sound port. These materials prevent the environmental elements from damaging a microphone membrane and typically look like membranes, such as those manufactured by W. L. Gore & Associates. However, these vents do not behave as thin plates and vents are not considered to be thin plates by those knowledgeable in the art.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. Therefore, to the extent there are variations of the invention that are within the spirit of the disclosure or equivalent to the inventions found in the claims, it is the intent that this patent will cover those variations as well.

To the extent that the claims recite the phrase “at least one of” in reference to a plurality of elements, this phrase is intended to mean at least one or more of the listed elements and is not limited to at least one of each element. For example, “at least one of an element A, element B, and element C,” is intended to indicate element A alone, or element B alone, or element C alone, or any combination thereof. “At least one of element A, element B, and element C” is not intended to be limited to at least one of an element A, at least one of an element B, and at least one of an element C.

This detailed description uses examples to disclose the invention, including the best mode, and to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated and in accordance with the following appended claims. Additional embodiments include any one of the embodiments described above and described in any and all exhibits and other materials submitted herewith, where one or more of its components, functionalities or structures is interchanged with, replaced by or augmented by one or more of the components, functionalities or structures of a different embodiment described above.

Accordingly, it is to be understood that the embodiments of the invention herein described are merely illustrative of the application of the principles of the invention. Other variations and modifications will be apparent to a person reading the description and as set forth in the following claims. Reference herein to details of the illustrated embodiments is not intended to limit the scope of the claims, which themselves recite those features regarded as essential to the invention.

What is claimed is:

1. A microphone comprising:
a housing;
a thin plate attached to the housing, the thin plate and the housing defining a first acoustic cavity;
a first printed circuit board attached to the housing;
a case attached to the first printed circuit board, the first printed circuit board and the case defining a second acoustic cavity;
a support structure attached to the first printed circuit board, the support structure being in the second acoustic cavity; and
a membrane attached to the support structure.

2. The microphone of claim 1, wherein the housing includes a base and an annular wall.

3. The microphone of claim 2, wherein the base includes a second printed circuit board.

4. The microphone of claim 2, wherein the first printed circuit board is attached to the base.

5. The microphone of claim 2, wherein a sound port extends through the base and the first printed circuit board.

6. The microphone of claim 2, wherein the first printed circuit board includes a vent hole therethrough.

7. The microphone of claim 1, wherein the housing includes a vent hole therethrough.

8. The microphone of claim 1, wherein a sound port extends through the first printed circuit board.

9. The microphone of claim 1, wherein the case is within the first acoustic cavity.

10. The microphone of claim 1, wherein the case is outside the first acoustic cavity.

11. The microphone of claim 1, wherein as a result of exposure to sound, pressure in the first acoustic cavity is attenuated by at least 10 dB compared to ambient pressure.

12. The microphone of claim 1, wherein a maximum dimension of the first acoustic cavity is less than 4.3 cm (approximately 1.69 inches).

13. The microphone of claim 1, wherein a compliance of the thin plate is less than one third the compliance of the first acoustic cavity.

14. The microphone of claim 1, wherein the membrane is in acoustic communication with the first acoustic cavity and the second acoustic cavity.

15. The microphone of claim 1, wherein the thin plate is made of metal.

16. A thin plate pressure attenuator comprising:
a housing including a base and an annular wall; and
a thin plate attached to the housing,
the housing and the thin plate defining a first acoustic sound cavity.

17. The thin plate pressure attenuator of claim 16, wherein the base includes a printed circuited board.

18. The thin plate pressure attenuator of claim 16, wherein the base includes a vent hole therethrough.

19. The thin plate pressure attenuator of claim 16, wherein the housing includes a first vent hole therethrough.

20. The thin plate pressure attenuator of claim 16, wherein the thin plate vibrates according to thin plate vibration theory.

21. The thin plate pressure attenuator of claim 16, wherein the thin plate is made of metal.

22. The thin plate pressure attenuator of claim 16, wherein a microphone is in fluid communication with the first acoustic sound cavity.

23. A thin plate pressure attenuator comprising:
a housing defining a sound cavity;
a thin plate attached to the housing; and
a microphone coupled to the sound cavity.

24. The thin plate pressure attenuator of claim 23 wherein the microphone is located outside the sound cavity of claim 1 and acoustically coupled to the sound cavity.

25. The thin plate pressure attenuator of claim 23 wherein the microphone is located inside the sound cavity.

26. The thin plate pressure attenuator of claim 23 wherein the pressure inside the sound cavity is attenuated by at least 10 dB.

27. The sound cavity of claim 23 wherein the maximum dimension of the sound cavity is less than 4.3 cm (approximately 1.69 inches).

28. The thin plate pressure attenuator of claim 23 where the compliance of the thin plate is less than ⅓ the compliance of the cavity.
